(19) United States
(12) Patent Application Publication
(10) Pub. No.: US 2015/0276514 A1
(43) Pub. Date: Oct. 1, 2015

(54) OPERATION INPUT DEVICE

(71) Applicant: DENSO CORPORATION, Kariya-city (JP)

(72) Inventors: Syunsuke SHIBATA, Nishio-city (JP); Norio SANMA, Okazaki-city (JP); Sei IGUCHI, Okazaki-city (JP)

(21) Appl. No.: 14/645,463

(22) Filed: Mar. 12, 2015

(30) Foreign Application Priority Data
Mar. 28, 2014 (JP) 2014-70020

(51) Int. Cl. G01L 1/22

(52) U.S. Cl. CPC G01L 1/22

(57) ABSTRACT

An operation input device includes a connection body that has two slopes respectively having an angle against an operation panel to form a gable roof shape, and each of the two slopes has a strain body disposed thereon, and an vertex of the roof-shaped slopes is positioned within a preset distance from an outer face of the operation panel, and the strain body, the connection body and a strain gauge are disposed in an inside of a box-shaped operation unit.

### CROSS REFERENCE TO RELATED APPLICATION

The present application is based on and claims the benefit of priority of Japanese Patent Application No. 2014-070020, filed on Mar. 28, 2014, the disclosure of which is incorporated herein by reference.

### TECHNICAL FIELD

The present disclosure generally relates to an operation input device for an input of a controlling operation that controls, for example, a vehicular navigation apparatus, an air conditioning apparatus, or an audio-visual apparatus.

### BACKGROUND INFORMATION

A conventional operation input device, as disclosed in a patent document 1, for example, has a panel that serves as an operation surface for a touch operation, strain gauge type sensors disposed at four corners of the panel for respectively detecting a perpendicular load applied on the panel, and an arithmetic circuit for calculating a position and a direction of the load based on the detected load from the strain gauges. Further, the panel of this operation input device has a stick that is integrally protruding therefrom and operable for an application of the load to the panel.

The operation input device of the patent document 1 (i.e., Japanese Patent Laid-Open No. 2010-86076) detects a position of a finger operation on the panel when a touch or a drag operation of a finger is performed on the panel, for an input of a control that is associated with a position of the finger operation or with a move/direction of the finger operation. In addition, a stick disposed on the panel is used for an input of various controls that are associated with a pull-up, a press-down, a tilt or the other operation of the stick.

However, the device in the patent document 1 is not capable of accurately detecting a position of the finger operation on the panel, especially when the finger operation on the panel diagonally applies the operation force to the panel, because the diagonal operation force is composed of a perpendicular component perpendicular to the operation surface of the panel and a horizontal component in parallel with the operation surface of the panel. More specifically, the horizontal component of the operation force causes an inaccurate reading/detection of the position of the finger operation on the panel.

### SUMMARY

It is an object of the present disclosure to provide an operation input device that is capable of accurately detecting a position of an input operation on an input panel, even when the input operation applies a diagonal force to the panel.

For a resolution of the above-described problem, the present disclosure provides the following technical solution. That is, in an aspect of the present disclosure, an operation input device includes an operation panel receiving a finger operation by an operator and an operation unit having an opening on one end and a chamber in which the operation panel is disposed, the operation unit being movable in at least one of an in-parallel direction that is a direction parallel to an outer face of the operation panel, a perpendicular direction that is a direction perpendicular to the outer face of the operation panel, or in a rotation direction along a perpendicular axis that is perpendicular to the outer face of the operation panel. The operation input device also includes a strain body elastically deformed by a force applied to the operation panel and the operation unit, a connection body connecting the operation panel and the operation unit with the strain body, and the connection body being at least partially deformed by the force applied to the operation panel and the operation unit, at least four strain gauges respectively gauging a deformation of the strain body caused by a deformation of the connection body, an operation position calculator calculating a position and a magnitude of the operation force applied to the operation panel and calculating the force applied to the operation unit and a rotational moment about the perpendicular axis based on a gauged strain by each of the at least four strain gauges, and a stay attached to the connection body. The connection body has a gable roof shape with two slopes angled at a preset angle against the operation panel. The strain body is disposed on each of the two slopes. A vertex of the gable roof shape is positioned within a preset distance from the outer face of the operation panel. The strain body, the connection body, and the strain gauge are disposed inside of the chamber of the operation unit.

Also, in an aspect of the present disclosure, the operation unit is a dial member that is rotatably operable about the perpendicular axis.

Further, in an aspect of the present disclosure, the preset distance is equal to one twentieth of a maximum dimension of the operation panel.

Additionally, in an aspect of the present disclosure, the preset distance is 2 millimeters.

Moreover, in an aspect of the present disclosure, the connection body is formed from an elastic material.

According to the above disclosure, when a diagonal operation force is applied to an outer face of the operation panel, a horizontal component of the diagonal operation force is transmitted to the strain body via the vertex of the connection body. The transmitted force may be further divided into two components, i.e., (i) an along-slope component that is in parallel with the slope and (ii) a perpendicular component that is perpendicular to the slope. Since the strain body has a high rigidity in an along-slope direction, the strain body does not have any sensitivity for the along-slope component of the transmitted force.

On the other hand, a force that is opposite to the perpendicular component (F1) is applied to the strain body due to a moment that is induced by the horizontal component. The force and the perpendicular component have the same magnitude and opposite directions, thereby cancelling each other.

Therefore, by disposing the slope on the connection body and putting the strain body on the slope, even when the diagonal operation force applied on the outer face of the operation panel causes the horizontal component that is in parallel with the outer face, the strain body is free from an influence of such horizontal component. Thus, the operation position of the diagonal operation force is accurately detected.

The numerals in the parentheses represent relationships between the claimed parts of the operation input device in the summary description in the above and the various practical components in the embodiment in the following.

### BRIEF DESCRIPTION OF THE DRAWINGS

Objects, features, and advantages of the present disclosure are more apparent from the following detailed description made with reference to the accompanying drawings, in which:

FIG. 1 is a block diagram of a navigation apparatus and an operation input device in a first embodiment of the present disclosure;

FIG. 2 is a perspective exploded view of the operation input device in the first embodiment of the present disclosure;

FIG. 3A is a plan view of the operation input device in the first embodiment of the present disclosure;

FIG. 3B is a sectional view of the operation input device in the first embodiment of the present disclosure;

FIG. 4A is a model diagram of a load on a strain body when a Z axis force is applied thereon;

FIG. 4B is a model diagram of a load on a strain body when a Z axis force is applied thereon;

FIG. 5A is a model diagram of a load on the strain body when a Y axis force is applied thereon;

FIG. 5B is a model diagram of a load on the strain body when a Y axis force is applied thereon;

FIG. 6A is a table diagram of a change of resistance of each of strain bodies that are shown in FIGS. 4A/B;

FIG. 6B is a schematic diagram of a bridge circuit formed by the strain bodies;

FIG. 7A is an illustration of how coordinates of a perpendicular force (Fz) are calculated when the perpendicular force is applied to an outer face of an operation panel;

FIG. 7B is an illustration of how coordinates of a perpendicular force (Fz) are calculated when the perpendicular force is applied to an outer face of an operation panel;

FIG. 8A is an illustration of how to detect a force along an X, Y, or Z axis, or how to detect a moment about the Z axis;

FIG. 8B is an illustration of how to detect a force along an X, Y, or Z axis, or how to detect a moment about the Z axis;

FIG. 8C is an illustration of how to detect a force along an X, Y, or Z axis, or how to detect a moment about the Z axis;

FIG. 8D is an illustration of how to detect a force along an X, Y, or Z axis, or how to detect a moment about the Z axis;

FIG. 9 is an illustration of how the diagonal operation force on the operation panel causes a load on the strain bodies;

FIG. 10 is a sectional view of a connection body in a second embodiment of the present disclosure; and

FIG. 11 is a sectional view of the connection body in other embodiments of the present disclosure.

### DETAILED DESCRIPTION

Embodiments of the present disclosure are described based on the drawings. In each of the embodiments, the same numerals may be borrowed from the preceding embodiment(s), and the description of the same parts may be not repeated. In each of the embodiments, the configuration may be fully described or partially described, in which case a non-described portion of the configuration may be borrowed from the preceding embodiment(s). The combination of the embodiments or parts of the embodiments should be permitted when not only it is explicitly described but also it is only implicitly described, unless otherwise indicated or unless any hindrance factor prevents the combination.

### First Embodiment

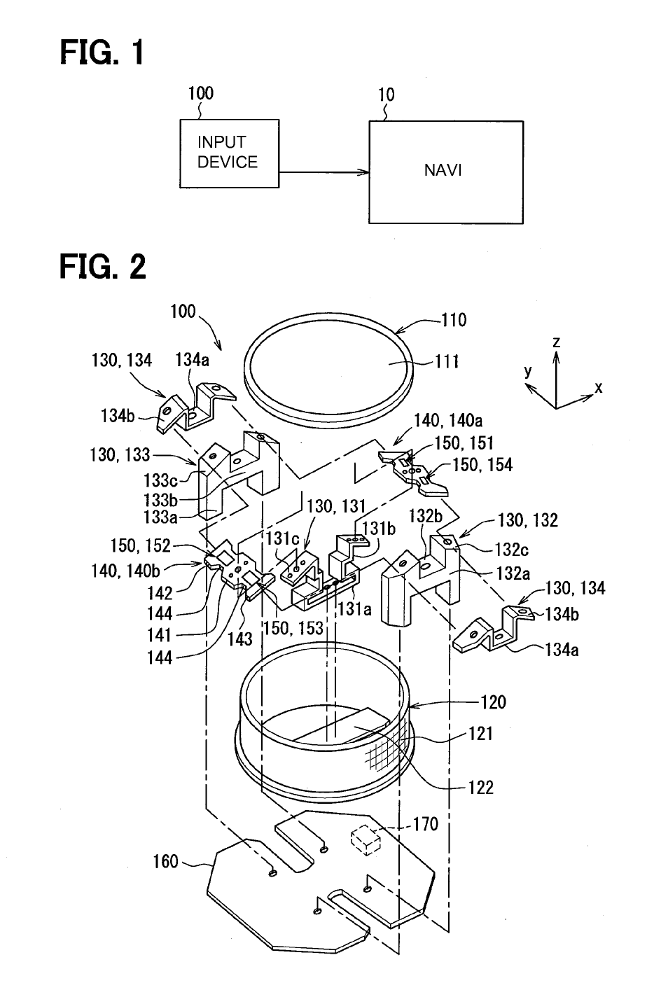

A configuration of an operation input device 100 in the first embodiment of the present disclosure is described with reference to FIGS. 1 to 6.

As shown in FIG. 1, the operation input device 100 is a device which performs an operation input for operating an in-vehicle navigation device 10, for example. The operation input device 100 may also be used for an input to various apparatus, e.g., an air-conditioner and audio equipment, other than the above-mentioned navigation device 10.

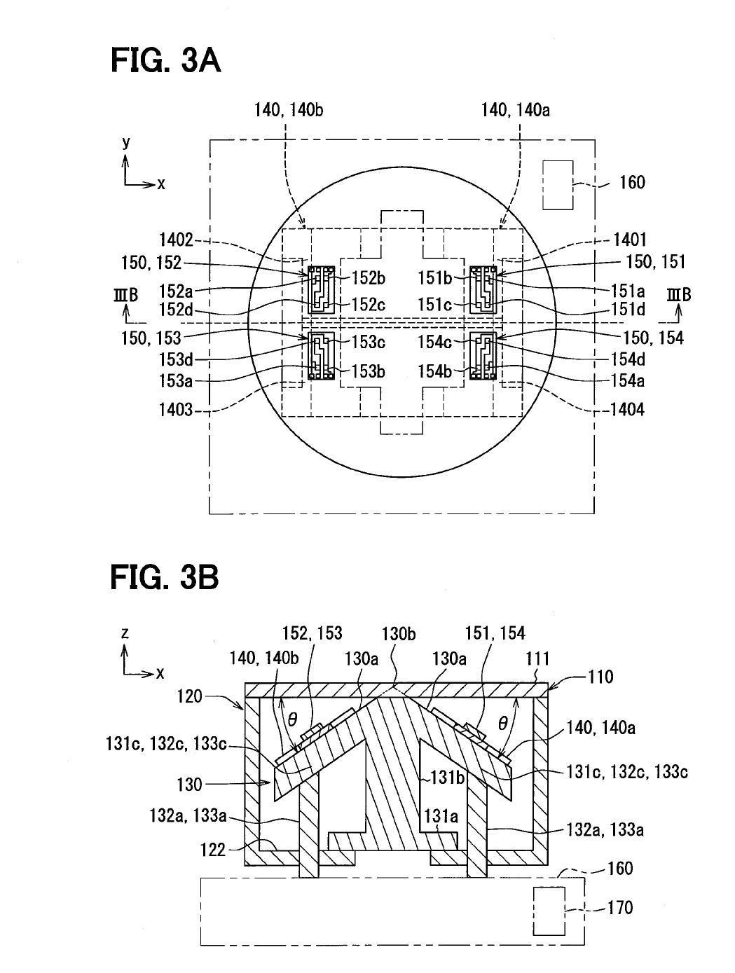

As shown in FIG. 2 and FIGS. 3A/B, the operation input device 100 is provided with an operation panel 110, an operation unit 120, a connection body 130, a strain body 140, a strain gauge 150, a stay 160, a signal processor 170 and the like. The connection body 130, the strain body 140, and the strain gauge 150 are disposed inside the operation unit 120.

The operation panel 110 is a circular tabular member. The operation panel 110 is a so-called touchpad for an operator to perform a finger operation (i.e., a touch, a drag, etc.). The operation panel 110 is fixedly arranged to cover a circular opening on one end of the operation unit 120 mentioned later. The face (i.e., an upper surface of FIG. 2 and FIGS. 3A/B) on the outside of the operation unit 120 of the operation panel 110 is designated as an outer face 111.

The operation panel 110 and its relevant parts are defined in a coordinate system of x, y, z axes, which has an origin at the center of the operation panel 110, with the x/y axes lying on the face 111 and z axis perpendicularly standing thereon. Those axes may also be used to refer to a vehicle orientation, which may be defined as a longitudinal direction of the vehicle aligned with the x axis, the lateral direction with the y axis, and the height direction with the z axis.

The operation unit 120 is a flat cylindrical member. The operation unit 120 may be an operation knob/dial that is grabbed or pinched with fingers by an operator, and may be pulled, tilted or twisted/rotated along and about each of those axes, for an operation input. The outside of the operation unit 120 is a side wall 121, which is provided with many lattice shape projection parts for preventing a slip of the finger in. An opening of the operation unit 120 on the other end side (i.e., an opposite side of the operation panel 110) has a connecting supporter 122 that connects, or bridges, the side wall 121 in a board shape extending along the x axis. The operation unit 120 is an element in the claims “having a chamber with an opening on one end.”

The connection body 130 connects (i) the operation panel 110 and the operation unit 120 and (ii) the strain body 140 mentioned later, and it serves as a connecting member that at least partially deformed by a force that is applied to the operation panel 110 and/or to the operation unit 120. The connection body 130 is provided with a first connection body 131, a second connection body 132, a third connection body 133, and a holding plate 134.

The first connection body 131 is formed, for example, by a bending work of a board shape member. The first connection body 131 includes a stationary part 131a with which the first connection body 131 is fixedly disposed on the connecting supporter 122, two projected parts 131b which project toward the operation panel 110 from the stationary part 131a, and two the slope parts 131c that diagonally extend away from the operation panel 110 at a preset angle. The slope parts 131c extend along the x axis, for example. Further, the slope parts 131c respectively have a screw hole for fixing the strain body 140 (i.e., 140a, 140b) mentioned later.

The second connection body 132 is a block member formed in an H letter shape, which is formed as two pillar parts 132a extending along a cylinder axis of the operation unit 120 and a connecting part 132b which connects/bridges the two pillar parts 132a at their intermediate portions. The end face of each of the pillar parts 132a, on one end close to the operation panel 110, is a slope part 132c. The slope part 132c is formed as an inclined face that extends from a longitudinal center of the connecting part 132b toward each of both outside ends thereof and diagonally away from the operation panel 110. The connecting part 132b and the slope part 132c respectively have a screw hole for fixing the holding plate 134 mentioned later.

The third connection body 133 has the same configuration as the above-mentioned the second connection body 132, and has two pillar parts 133a, a connecting part 133b, and a slope part 133c. The screw hole for fixing the holding plate 134 mentioned later is formed on the connecting part 133b and the slope part 133c.

The second connection body 132 and the third connection body 133 are arranged to bind the first connection body 131, and an opposite end of each of the pillar parts 132a and 133a away from the operation panel 110 is, passing out of the opening of the operation unit 120 beside the connecting supporter 122, fixedly disposed on the stay 160 that is mentioned later. Therefore, the opposite side end of the operation unit 120, opposite to the operation panel 110, is not in contact with the stay 160 with some gap.

A part of each of the slope parts 131c to 133c close to the operation panel 110 is connected to a reverse side face of the operation panel 110. The slope parts 131c to 133c of the first to third connection bodies 131 to 133 are included in two virtual slopes 130a, and the two virtual slopes make a gable roof shape, respectively having a preset angle (i.e., θ in FIGS. 3A/B) against the operation panel 110. In other words, the slope parts 131c to 133c substantially make two slopes 130a.

Further, an intersection of the two slopes 130a on or around the operation panel 110 is a vertex 130b (see FIG. 3B). The vertex 130b is positioned within a preset distance toward the connecting supporter 122 from the outer face 111 of the operation panel. The preset distance may be, for example, one twentieth of the maximum dimension (i.e., a diameter) of the panel 110. The preset distance may also be 2 millimeters. The preset distance of 2 millimeters is substantially equal to the thickness of the operation panel 110. Further, the preset distance may also be equal to 0 (zero), which means that the vertex 130b is positioned on the outer face 111 of the operation panel 110.

The holding plate 134 is formed, for example, by a bending work of the board shape member, and two pieces of the holding plate 134 are used to hold the strain body 140 on the second connection body 132 and on the third connection body 133. The holding plate 134 is formed to fit to the shape of the connecting parts 132b and 133b and to the shape of the slope parts 132c and 133c of the second and third connection bodies 132 and 133, and it includes a body part 134a and a holding part 134b. The body part 134a and the holding part 134b respectively have a screw hole for fixing themselves onto the second and third connection bodies 132 and 133.

The holding part 134b firmly fixes side ends 142 and 143 of the strain body 140 (140a, 140b) mentioned later together with the slope parts 132c and 133c of the second and third connection bodies 132 and 133 in a binding manner.

The strain body 140 which is disposed on the connection body 130 is a board shape member of an I letter shape, and is elastically distorted and strained by a force that is applied to the operation panel 110 and/or to the operation unit 120. The strain body 140 is formed as a first strain body 140a, and a second strain body 140b. The two strain bodies 140a and 140b have the same configuration. Both strain bodies 140a and 140b have a central stationary portion 141, the side ends 142 and 143, and a gauge holder 144.

The central stationary portion 141 has an increased width at its center part in the longitudinal direction, where a screw hole is provided. The side ends 142 and 143 are a longitudinal end part on both ends of the I letter shape. The central stationary portion 141 is fixed to the slope part 131c of the first connection body 131. The side ends 142 and 143 are in contact with the slope parts 132c and 133c of the second and third connection bodies 132 and 133. The side ends 142 and 143 are held by the holding part 134b of the holding plate 134 onto the slope parts 132c and 133c.

The gauge holder 144 is formed at a position between the central stationary portion 141 and each of the side ends 142 and 143, and serves as a region where the strain gauge 150 which is mentioned later is positioned. In each of the first and second strain bodies 140a and 140b, two gauge holders 144 are provided, respectively. As shown in FIG. 3A, two regions corresponding to two gauge holders 144 of the first strain body 140a are hereafter designated as a first region 1401 and a fourth region 1404. Similarly, two regions corresponding to two gauge holders 144 of the second strain body 140b are hereafter designated as a second region 1402 and a third region 1403.

The first strain body 140a and the second strain body 140b are disposed on the two slopes 130a of the connection body 130, respectively, as shown in FIG. 3B, which means that those bodies 140a, 140b make an A letter shape with the angle θ against the operation panel 110 if seen along the y axis.

The strain gauge 150 is a detector for detecting a distortion or a strain of the strain body 140 that is caused by the distortion of the connection body 130 due to the operation force applied to the operation panel 110 and/or to the operation unit 120. Four strain gauges 150 are provided respectively in a corresponding manner to the four gauge holders 144 on the strain bodies 140a and 140b. The four strain gauges 150 are designated as a first strain gauge 151, a second strain gauge 152, a third strain gauge 153, and a fourth strain gauge 154.

The first strain gauge 151 is positioned in the first region 1401 of the first strain body 140a. The second strain gauge 152 is positioned in the second region 1402 of the second strain body 140b. The third strain gauge 153 is positioned in the third region 1403 of the second strain body 140b. The fourth strain gauge 154 is positioned in the fourth region 1404 of the first strain body 140a.

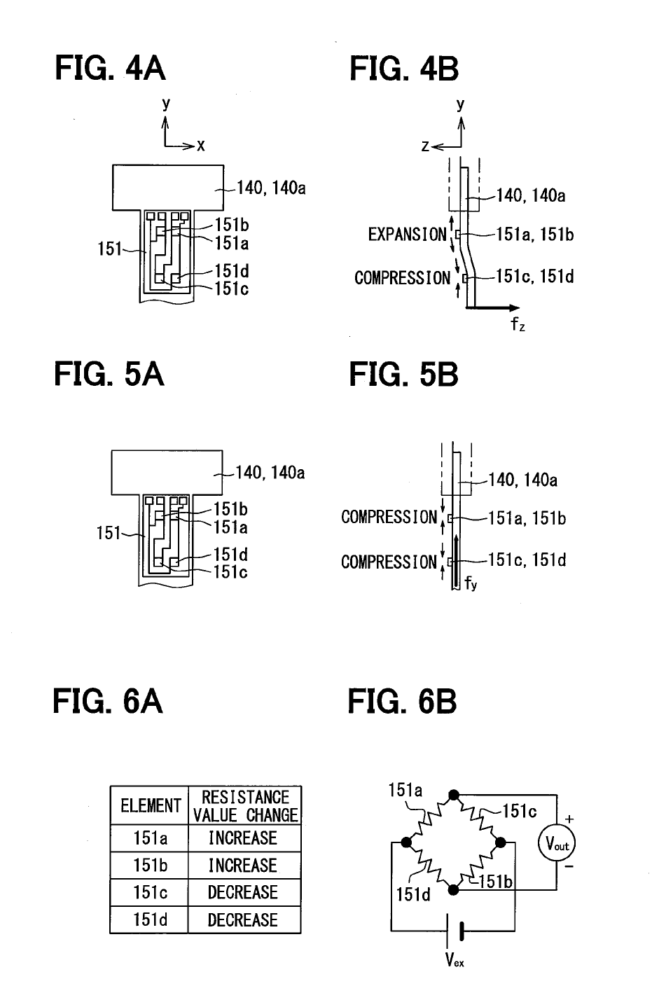

Each of the strain gauges 151 to 154 have four strain gauge elements, respectively, as shown in FIG. 3A, FIGS. 4A/B, and FIGS. 5A/B. That is, the first strain gauge 151 has strain gauge elements 151a, 151b, 151c, and 151d. Similarly, the second strain gauge 152 has strain gauge elements 152a, 152b, 152c, and 152d. Similarly, the third strain gauge 153 has strain gauge elements 153a, 153b, 153c, and 153d. Similarly, the fourth strain gauge 154 has strain gauge elements 154a, 154b, 154c, and 154d.

In the present embodiment, as strain gauge elements 151a-151d and 152a-152d and 153a-153d and 154a-154d of each of the strain gauges 151 to 154, the distortion detecting element (i.e., a strain gage) is used, in which the electric resistance value changes according to the distortion of the strain body 140 (i.e., the first and second strain bodies 140a and 140b), for example.

In each of the strain gauges 151 to 154, a bridge circuit as shown in FIG. 6B is formed by the four strain gauge elements, i.e., by the elements 151a-151d, 152a-152d, 153a-153d, and 154a-154d. The voltage (Vout) of the midpoint of each bridge circuit is output to the signal processor 170 which is mentioned later, respectively.

The stay 160 is a stationary pedestal component which stationarily holds the connection body 130, for example, and is formed in a board shape. More practically, the opposite side end opposite to the operation panel 110 in each of the pillar parts 132a and 133a of the second and third connection bodies 132 and 133 is fixed to the stay 160. Therefore, the operation unit 120 and the operation panel 110 are fixed to the stay 160 via the connection body 130.

The signal processor 170 is an operative position calculation part provided in the stay 160. The signal processor 170 calculates the magnitude of the operation force applied to the operation panel 110 and the position of the operation force (i.e., the operation position) based on the output voltage from each of the strain gauges 151 to 154. The signal processor 170 further calculates the direction (i.e., x, y, z axis directions) and magnitude of the operation force which is applied to the operation unit 120, and also calculates the direction and magnitude of a moment of such operation force along a circumference direction about the z-axis. Then, based on the calculation result, the display operation of the navigation device 10 is controlled. For example, a selection of menu icons, and an OK operation for determining the selection, as well as a screen switching for a position display of the own vehicle on the map and a destination guidance, map scrolling are enabled according to the calculation of the position and direction of the operation force.

Next, the operation of the operation input device 100 constituted as mentioned above is described in detail.

As shown in FIGS. 4A/B and FIGS. 5A/B, operation forces (fz, fy, etc.) are transmitted to the strain body 140 (140a, 140b) via the connection body 130 when the operation panel 110 or the operation unit 120 is operated by an operator. Then, according to the applied force, the strain body 140 is either pulled or compressed, and an expansive or compressive deformation is caused therein. As shown in FIG. 6A, the resistance value of the distortion detecting element increases when the element is pulled or expanded (i.e., 151a, 151b of FIGS. 4A/B), or decreases when the element is compressed (i.e., 151c, 151d of FIGS. 4A/B, 151a-151d of FIGS. 5A/B). Thus, an output voltage value of the bridge circuit changes when the resistance value of each of the strain gauge elements 151a to 151d changes.

According to the position, the direction and the magnitude of the operation force applied to the operation panel 110 or the operation unit 120, the output voltage values from the strain gauges 151 to 154 differ, respectively. Therefore, the signal processor 170 can recognize the operation force that is applied to the operation panel 110 or the operation unit 120, i.e., the position, the direction and the magnitude of the operation force, based on the output voltage value in each of the strain gauges 151 to 154.

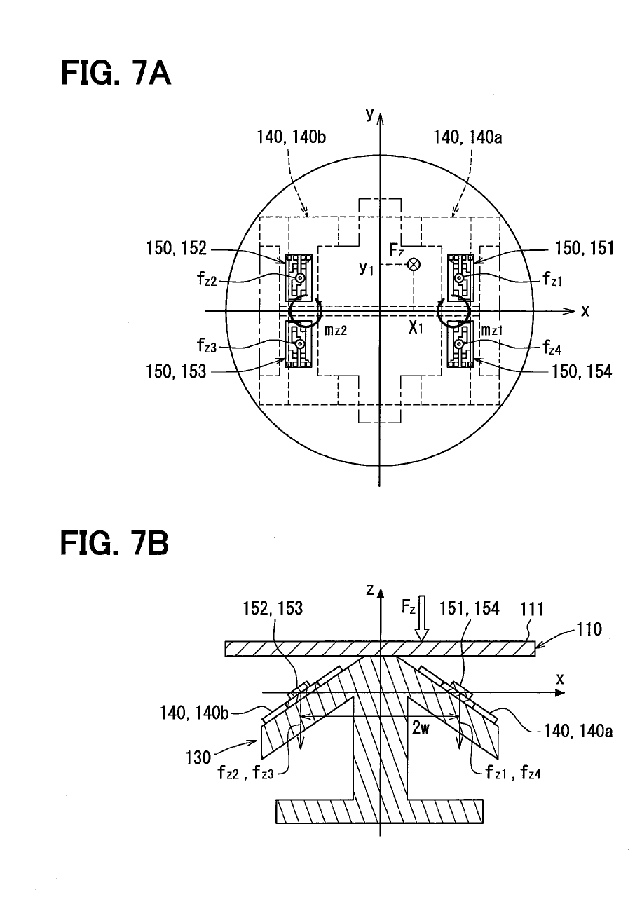

Hereafter, with reference to FIGS. 7A/B, 8A/B/C/D, and 9, a method of recognizing the different operation forces from different operations is described.

1. When the Operation Force is Applied to the Operation Panel 110 Along the z Axis

As shown in FIGS. 7A/B, when an operation force Fz along the z axis is applied to the operation panel 110 by a touch operation (i.e., a tap) of the operator at position coordinates of x1, y1, the force along the z axis transmitted to each of the strain gauges 151 to 154 is sensed as fz1, fz2, fz3, and fz4, respectively and the force Fz is thus represented by an equation 1.

Fz=fz1+fz2+fz3+fz4 (Equation 1)

A moment Fx·x1 about the y axis by the operation force Fx is represented by an equation 2 when a distance along the x axis from the origin to the strain gauges 151 and 154 and a distance along the x axis from the origin to the strain gauges 152 and 153 are designated as w, respectively.

Fx·x1=(fz1+fz4)·w−(fz2+fz3)·w (Equation 2)

A moment Fx·y1 about the x axis by the operation force Fx is represented by an equation 3 when a moment about the x axis according to the difference between the force fz1 and the force fz4 is designated as mz1, and a moment about the x axis according to the difference between the force fz2 and the force fz3 is designated as mz2.

Fx·y1=mz1+mz2 (Equation 3)

Therefore, based on the equation 1 and the equation 2, an equation 4 is composed.

x1={(fz1+fz4)−(fz2+fz3)}·w/(fz1+fz2+fz3+fz4) (Equation 4)

Further, based on the equation 1 and the equation 3, an equation 5 is composed.

y1=(mz1+mz2)/(fz1+fz2+fz3+fz4) (Equation 5)

That is, the position (x, y coordinate positions) of the applied operation force can be grasped based on the forces fz1 to fz4 obtained from each of the strain gauges 151 to 154 and the moments mz1, mz2.

2. When the Operation Force is Applied to the Operation Unit 120 Along Each of x, y, z Axes and about the z Axis
(1) The Operation Force Along the x Axis

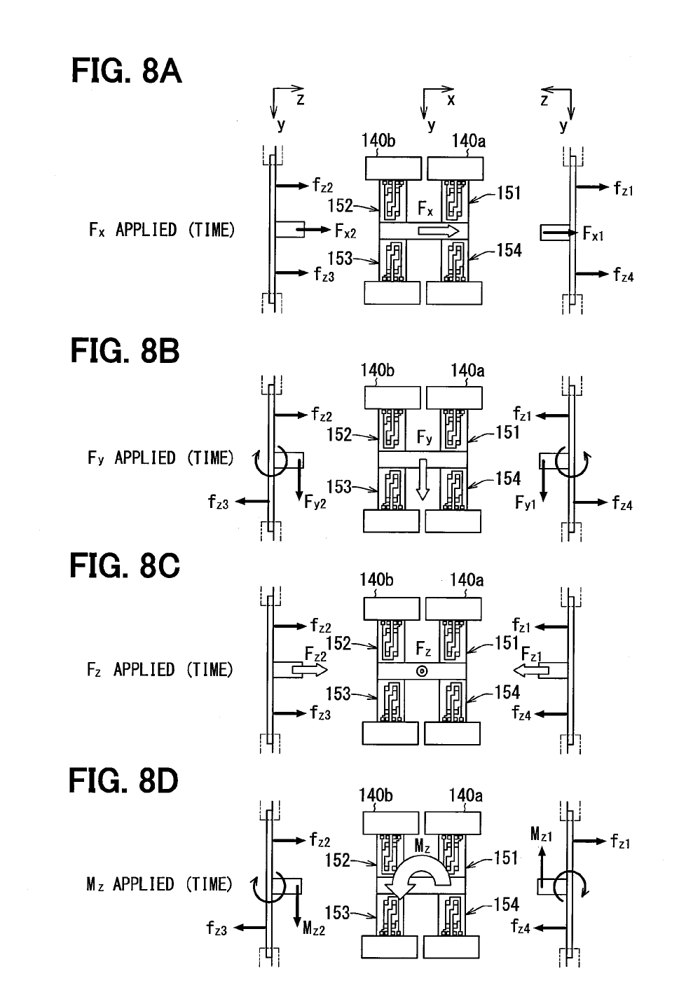

As shown in FIG. 8A, when the operation force Fx along the x axis is applied to the operation unit 120, a force Fx1 acts on the central part (i.e., on the central stationary portion 141) of the first strain body 140a in the minus direction of the z axis. Thereby, the forces fz1 and fz4 act on the first strain gauge 151 and the fourth strain gauge 154 in the minus direction of the z axis, respectively.

Further, a force Fx2 acts on the central part (i.e., the central stationary portion 141) of the second strain body 140b in the plus direction of the z axis. Thereby, the forces fz2 and fz3 act on the second strain gauge 152 and the third strain gauge 153 in the plus direction of the z axis, respectively.

(2) The Operation Force Along the y Axis

As shown in FIG. 8B, when the operation force Fy along the y axis is applied to the operation unit 120, a force Fy1 acts on the central part (i.e., the central stationary portion 141) of the first strain body 140a in the minus direction of the y axis. Then, due to a moment that is caused by the force Fy1, the force fz1 acts on the first strain gauge 151 in the plus direction of the z axis, and the force fz4 acts on the fourth strain gauge 154 in the minus direction of the z axis.

Further, the force Fy2 acts on the central part (i.e., the central stationary portion 141) of the second strain body 140b in the minus direction of the y axis.

Then, due to a moment that is caused by the force Fy2, the force fz2 acts on the second strain gauge 152 in the plus direction of the z axis, and the force fz3 acts on the third strain gauge 153 in the minus direction of the z axis.

(3) The Operation Force Along the z Axis

As shown in FIG. 8C, when the operation force Fz along the z axis (i.e., in a pull-up direction or in a press-down direction) is applied to the operation unit 120, a force Fz1 acts on the central part (i.e., the central stationary portion 141) of the first strain body 140a in the plus direction of the z axis. Thereby, the forces fz1 and fz4 act on the first strain gauge 151 and the fourth strain gauge 154 in the plus direction of the z axis, respectively.

Further, the force Fx2 acts on the central part (i.e., the central stationary portion 141) of the second strain body 140b in the plus direction of the z axis. Thereby, the forces fz2 and fz3 act on the second strain gauge 152 and the third strain gauge 153 in the plus direction of the z axis, respectively.

(4) The Operation Force about the y Axis

As shown in FIG. 8D, when the operation force Mz about the z axis is applied to the operation unit 120, a force Mz1 acts on the central part (i.e., the central stationary portion 141) of the first strain body 140a in the plus direction of the y axis. Then, due to a moment that is caused by the force Mz1, the force fz1 acts on the first strain gauge 151 in the minus direction of the z axis, and the force fz4 acts on the fourth strain gauge 154 in the plus direction of the z axis.

Further, a force Mz2 acts on the central part (i.e., the central stationary portion 141) of the second strain body 140b in the minus direction of the y axis. Then, due to a moment that is caused by the force Mz2, the force fz2 acts on the second strain gauge 152 in the plus direction of the z axis, and the force fz3 acts on the third strain gauge 153 in the minus direction of the z axis.

Based on the above descriptions (1) to (4), the combination of force directions regarding the forces fz1 to fz4 that are generated in each of the strain gauges 151 to 154 is different for each of the operation forces Fx, Fy, Fz, and Mz. Therefore, based on such different combinations of the force directions, the operation of the operation unit 120 is detected and recognized, in terms of which one of the three axes the operation force is oriented, and in terms of whether the operation force about the z axis is caused.

3. When Operation Force is Diagonally Applied to the Operation Panel 110

For the ease of description and understanding, an operation force F applied in a diagonal direction to the first strain body 140a is described as an example.

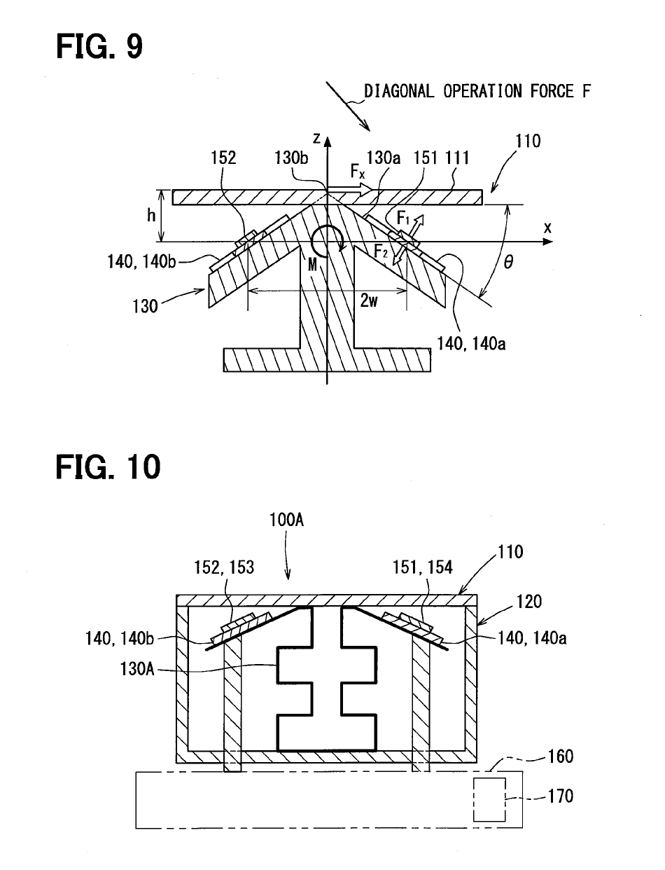

As shown in FIG. 9, when the operation force F in a diagonal direction is applied to the operation panel 110, the component of the force F along the x axis is designated as Fx. This component Fx is transmitted to the first strain body 140a from the vertex 130b of the connection body 130. The transmitted force can be divided into two forces, i.e., a force along the slope 130a and a force F1 which is perpendicular to the slope 130a. The first strain body 140a is a board shape component, and, due to its high rigidity along the slope 130a, it does not have any sensitivity for a force in the along-slope direction, which is applied along the slope 130a. Further, the force F1 may be represented by an equation 6.

F1=Fx·sin θ (Equation 6)

On the other hand, when a distance between the outer face 111 of the operation panel 110 and the x axis is designated as h, a moment M about the y axis caused by the force Fx may be represented by an equation 7.

M=Fx·h (Equation 7)

Due to such a moment M, a force F2 that has an opposite direction to the force F1 is caused in the first strain body 140a. The moment M2 caused by the force F2 may be represented by an equation 8.

M2=F2·w/cos θ (Equation 8)

Since the moment M is equal to the moment M2 in its magnitude, based on the equation 7 and the equation 8, an equation 9 is derived.

Fx·h=F2·w/cos θ (Equation 9)

Therefore, based on the equation 9, an equation 10 is derived.

F2=Fx·h·cos θ/w (Equation 10)

Here, since h/w=tan θ, based on the equation 10, an equation 11 is derived.

F2=Fx·tan θ·cos θ=Fx·sin θ (Equation 11)

Therefore, based on the equation 6 and the equation 11, an equation 12 is derived.

F1=F2 (Equation 12)

That is, in summary, both the force F1 and the force F2 having the same magnitude and opposite directions act on the first strain body 140a to cancel each other, thereby preventing the first strain body 140a to be affected by the force Fx of the diagonal operation force F that is diagonally applied to the operation panel 110. Therefore, the position of the diagonally-applied operation force on the operation panel 110 is accurately detected.

### Second Embodiment

An operation input device 100A of the second embodiment is shown in FIG. 10. In the present embodiment, the shape of the connection body 130 is changed from the one in the above-described first embodiment, to have a connection body 130A.

The connection body 130A is formed with a single flat spring that is bent two or more times. The flat spring may be formed, for example, by a press process. A part of the connection body 130A is formed to have a thin board. The number of the bending of the body 130A as well as the x/y axis dimension of the flat spring and the z axis height of the flat spring after bending are respectively predetermined together with other conditions.

The connection body 130A provides, other than a holding function that fixedly holds the operation panel 110, the operation unit 120, and the strain body 140, an operation force transmitting function that transmits, to the strain body 140, the operation force applied to the operation unit 120.

In particular, the moment about the z axis may be transmitted in an amplified manner to the strain body 140 when a part of the connection body 130A is made thinner. That is, the amount of deformation of the strain body 140 for the same twisting moment may be increased in such manner.

By providing the connection body 130A as the flat spring, the connection body 130A serves as a connection body as well as serving as an elastic body. By having an elastic body, the operation panel 110 and the operation unit 120 may be more easily moved/displaced by the operation force, thereby making it easier for those parts 110, 120 to detect the operation force from the operator.

Further, by folding the flat spring in many times, i.e., by the adjustment of the number of foldings and the dimensions of the folded portions, the displacement of the operation unit 120 caused by the x axis force and the displacement of the same unit by the y axis force may be substantially equated. That is, the natural and unbiased operation feeling of the operation unit 120 may be realized in such manner.

### Other Embodiments

Although the present disclosure has been fully described in connection with preferred embodiment thereof with reference to the accompanying drawings, it is to be noted that various changes and modifications is apparent to those skilled in the art.

According to each of the above-mentioned embodiments, the angle θ of the slope 130a of the connection body 130 is the same for both of a first strain body 140a side and a second strain body 140b side.

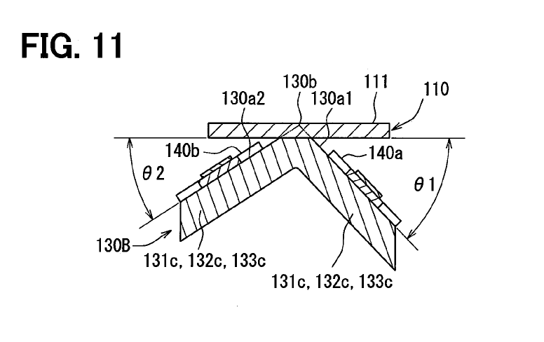

However, as shown in FIG. 11, the slope angle may be different on the respective sides. That is, an angle θ1 of the slope 130a1 on the first strain body 140a side and an angle θ2 of the slope 130a2 on the second strain body 140b side may be different from each other in a connection body 130B. In such manner, a manufacturing error (i.e., dimension errors at the time of manufacturing the device 100) may be adjusted or absorbed.

Although the strain body 140 may be formed as two separate parts 140a and 140b respectively having the I letter shape in the above, the strain body 140 may be made in one body, i.e., as a bending work of one board for having an L letter shape. Further, the four strain gauges 151 to 154 may be formed in one body, i.e., as one strain body on one board. Alternatively, the four gauges 151 to 154 may be separately disposed on respectively different four strain bodies.

Further, the outer face 111 of the operation panel 110 may have grooves, concaves, convexes, and the like. The grooves on the face 111 may be used to stabilize a slide operation by the finger on the panel 110, for example. Further, the concave/convex at the center of the face 111 may allow the operator to sense the whereabout/position of the finger in a tactile manner on the panel 110, without forcing the operator to watch the operating finger. That allows, in other words, an easy operation of the operation input device 100 for various controls based on the tactile sense of a reference position.

Further, in the above embodiments, each of the strain gauges 151 to 154 of the strain gauge 150 is made from four strain gauge elements 151a-151d, 152a-152d, 153a-153d, and 154a-154d, respectively. However, each of the strain gauges 151 to 154 may be made from only one distortion detecting element. That is, at least four strain gauges 150 may suffice.

Further, the x/y/z axes respectively defined as the lateral/longitudinal/height directions of the vehicle may be differently defined, depending on the situations. That is, according to the installation position of the operation input devices 100 and 100A, the x/y/z axes may be defined as the lateral/height/longitudinal directions relative to the vehicle, for example.

Further, the shape of the operation unit 120 (i.e., of the operation panel 110) is not restricted to the cylindrical shape. That is, the shape of the operation unit 120 and/or the operation panel 110 may be a polygonal shape or the like.

Such changes, modifications, and summarized schemes are to be understood as being within the scope of the present disclosure as defined by appended claims.

What is claimed is:

1. An operation input device comprising:
an operation panel receiving a finger operation by an operator;
an operation unit having an opening on one end and a chamber in which the operation panel is disposed, the operation unit being movable in at least one of an in-parallel direction that is a direction parallel to an outer face of the operation panel, a perpendicular direction that is a direction perpendicular to the outer face of the operation panel, or a rotation direction along a perpendicular axis that is perpendicular to the outer face of the operation panel;
a strain body elastically deformed by a force applied to the operation panel and the operation unit;
a connection body connecting the operation panel and the operation unit with the strain body, and the connection body being at least partially deformed by the force applied to the operation panel and the operation unit;
at least four strain gauges respectively gauging a deformation of the strain body caused by a deformation of the connection body;
an operation position calculator calculating a position and a magnitude of the operation force applied to the operation panel and calculating the force applied to the operation unit and a rotational moment about the perpendicular axis based on a gauged strain by each of the at least four strain gauges; and
a stay attached to the connection body, wherein
the connection body has a gable roof shape with two slopes angled at a preset angle against the operation panel,
the strain body is disposed on each of the two slopes,
a vertex of the gable roof shape is positioned within a preset distance from the outer face of the operation panel, and
the strain body, the connection body, and the strain gauge are disposed inside of the chamber of the operation unit.

2. The operation input device of claim 1, wherein
the operation unit is a dial member that is rotatably operable about the perpendicular axis.

3. The operation input device of claim 1, wherein
the preset distance is equal to one twentieth of a maximum dimension of the operation panel.

4. The operation input device of claim 1, wherein
the preset distance is 2 millimeters.

5. The operation input device of claim 1, wherein
the connection body is formed from an elastic material.
